(19) United States
(12) Patent Application Publication
(10) Pub. No.: US 2018/0302719 A1
(43) Pub. Date: Oct. 18, 2018

(54) CARBON FIBER DOME AND METHOD FOR MANUFACTURING THE SAME

(71) Applicant: AAC Technologies Pte. Ltd., Singapore city (SG)

(72) Inventors: Xun Di, Shenzhen (CN); Bin Zhao, Shenzhen (CN)

(21) Appl. No.: 15/646,777

(22) Filed: Jul. 11, 2017

(30) Foreign Application Priority Data
Apr. 13, 2017 (CN) 201710237833.3

(51) Int. Cl. H04R 7/12; B32B 37/14; B32B 5/02; H04R 31/00; C08J 5/24

(52) U.S. Cl. CPC H04R 7/122; C08J 2365/02; B32B 5/02; H04R 31/003; H04R 7/127; C08J 5/24; B32B 2307/10; B32B 2309/105; B32B 2305/076; H04R 2307/023; C08J 2363/00; C08J 2361/00; C08J 2377/00; C08J 2381/04; B32B 37/14

(57) ABSTRACT

The present disclosure relates to a carbon fiber dome including at least two carbon fiber prepreg layers, and the at least two carbon fiber prepreg layers include at least two types of carbon fiber materials. The present disclosure further relates to a method for manufacturing the carbon fiber dome, including: impregnating at least two types of carbon fiber materials with a prepreg resin to form at least two carbon fiber prepreg layers; and laminating the at least two carbon fiber prepreg layers after being impregnated. The carbon fiber prepreg is used to substitute the aluminum foil, thus, the strength is improved, the thickness is reduced and the sounding quality is improved, further, the carbon fiber material prepreg layers tightly adheres to each other to form an integrated structure, so that splitting of layers is avoided, and the dome has better water-proof effect and longer service life.

### TECHNICAL FIELD

The present disclosure relates to the field of electro-acoustic devices and, specifically, relates to a carbon fiber dome and a method for manufacturing the carbon fiber dome.

### BACKGROUND

A dome speaker refers to a speaker using a dome diaphragm to directly radiate sound waves. The speaker is an electric speaker, the diaphragm is a semi-sphere film, the speaker does not include a centering support, a voice coil of the speaker is directly supported by a suspension of the diaphragm, and the speaker has advantages like good high-frequency response, wide directivity and less distortion. A dome portion of the diaphragm is usually compositely formed by an aluminum foil and a foaming material. With the development of electronic industries, there is an increasing demand on performance and reliability of an electro-acoustic system, and there is also an increasing demand on the dome accordingly. However, the existing dome made from the aluminum foil and the foaming material has various deficiencies, for example, the aluminum foil cracks or breaks, the aluminum foil and the foaming material split into a plurality of layers, the material of the dome has insufficient strength, etc., therefore, the dome of the prior art cannot satisfy utilization requirements. In another aspect, the aluminum foil, as an observable component of the dome, is soft and is easily subjected to contamination and scratches, and thus is unaesthetic in appearance; further, the foaming material readily deforms after a force is applied thereon but then is hard to recover, which cannot bear pressure and absorbs water easily, thus, splitting readily occurs between the aluminum foil and the foaming material. Additionally, in order to achieve a set vibrating strength and guarantee mechanical properties, the dome adopts a composite layer of the foaming material and the aluminum foil with a great thickness.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a carbon fiber dome in accordance with an exemplary embodiment of the present disclosure;

FIG. 2 is a structural schematic diagram of a carbon fiber dome structured as a three-layer structure in accordance with an exemplary embodiment of the present disclosure;

FIG. 3 is a structural schematic diagram of a carbon fiber dome structured as a four-layer structure in accordance with an exemplary embodiment of the present disclosure;

FIG. 4 is a structural schematic diagram of a carbon fiber dome structured as a three-layer structure in accordance with another exemplary embodiment of the present disclosure;

FIG. 5 is a structural schematic diagram of a carbon fiber dome in accordance with another exemplary embodiment of the present disclosure; and

FIG. 6 is a schematic flow diagram of a method for manufacturing a carbon fiber dome in accordance with an exemplary embodiment of the present disclosure.

### DESCRIPTION OF EMBODIMENTS

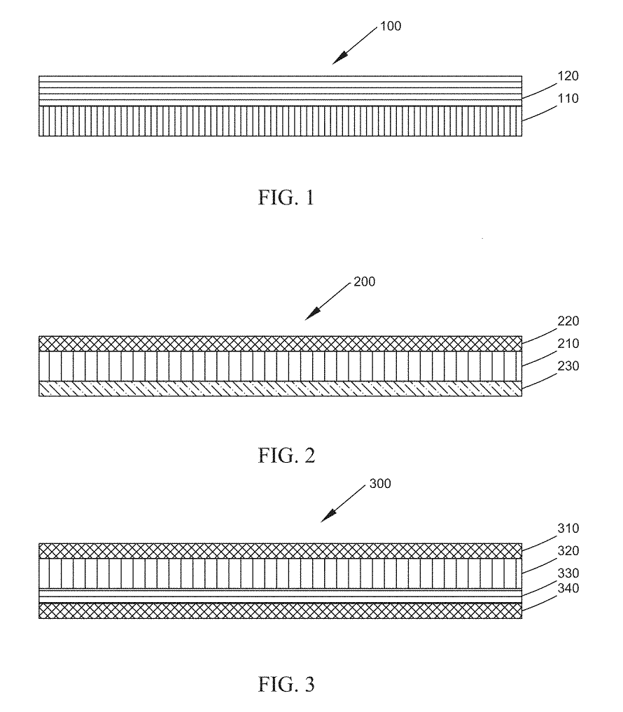

The present disclosure is described in detail as follows with reference to FIGS. 1-6.

An existing dome is a composite laminate of a foaming material layer and an aluminum foil layer. The foaming material and the aluminum foil are two different materials, and thus the foaming material layer is not attached tightly to the aluminum foil layer, therefore, splitting of layers will occur, and the dome has poor water-proof performance and easily absorb water. Additionally, different materials have different sound characteristics which will also worsen sound quality; further, a method for manufacturing the dome composed of different materials is complicate accordingly.

In order to overcome problems of the dome of the prior art, e.g., fragility, easy delamination, insufficient strength, unaesthetic appearance, great thickness and poor water-proof effect, etc., the present disclosure provides a dome made by using a carbon fiber material to substitute the existing aluminum foil and foaming material, so that the method for manufacturing the dome is simplified and can be easily controlled. Further, since merely the carbon fiber material is used, so that the layer splitting phenomenon caused by using different materials will be avoided. Moreover, the carbon fiber material after being laminated can provide sufficient strength and thus can meet the utilization requirements, and the thickness of the dome can also be smaller than the laminate of the foaming material and the aluminum foil. Specifically, the present disclosure provides a carbon fiber dome, the carbon fiber dome includes at least two layers of carbon fiber prepreg, and the at least two layers of carbon fiber prepreg includes at least two types of carbon fiber materials. In the present disclosure, the dome is formed by laminating at least two layers of carbon fiber prepreg, i.e., the dome is manufactured by using merely the carbon fiber material, so that different layers of the dome can be tightly attached to each other. Besides, the carbon fiber material performs well in bearing force, and thus the strength of the dome is guaranteed. Additionally, a resin in the carbon fiber prepreg cures during lamination, which further improves the strength and guarantees good surface finish and aesthetic appearance as well.

Further, the at least two layers of carbon fiber prepreg use at least two types of carbon fiber materials, so that problems caused by using a single carbon fiber material can be avoided. For example, if merely an M-series carbon fiber, which is coarse and has a wide gap and a rough surface, is used, the laminated material will have a rough surface, so that the mechanical property and acoustic property will be adversely influenced. If merely a T-series carbon fiber is used, problems like insufficient strength and weak bonding will appear. In an exemplary embodiment of the present disclosure, two types of carbon fiber are used to form the at least two layers of carbon fiber prepreg, so that the two layers can be tightly attached to each other, and the formed dome can have advantages like high strength, good water-proof effect, smooth surface and good acoustic vibration performance, i.e., the formed dome has both high strength and high ductility. It should be noted that, the T-series and M-series are carbon fiber modes of Toray Corporation, and belong to industry standards. Those skilled in the art can easily acquire the T-series carbon fiber and the M-series carbon fiber.

In the present disclosure, the dome is made from the carbon fiber material, and has great specific strength. Further, under identical strength, the dome of the present disclosure can be thinner than the dome of the prior art. Moreover, the dome and the voice diaphragm can be integrated as a whole. Besides, the dome is solid, which does not absorb water and has better water-proof performance In the dome, the carbon fiber layers can be well adhered to each other, and splitting of layers does not readily occur.

Specifically, as shown in FIG. 1, a carbon fiber dome 100 is provided according to an exemplary embodiment of the present disclosure. The carbon fiber dome 100 includes a first carbon fiber layer 110 and a second carbon fiber layer 120 located on the first carbon fiber layer 110. Both the first carbon fiber layer 110 and the second carbon fiber 120 include a carbon fiber prepreg, and the carbon fiber prepreg in the first carbon fiber layer 110 is different from the carbon fiber prepreg in the second carbon fiber layer 120, for example, the carbon fiber prepreg in the first carbon fiber layer 110 is the T-series carbon fiber prepreg, e.g., T300, T400, T700, etc.; the carbon fiber prepreg in the second carbon fiber layer 120 is the M-series carbon fiber prepreg, e.g., M30, M35, M40, M45, M50, M55, etc.; or vice versa. Under high temperature and high pressure, a prepreg resin in the first carbon fiber layer 110 and a prepreg resin in the second carbon fiber layer 120 cure to form an integral composite layer, so that the toughness and vibrating performance of the dome are guaranteed. Further, as a function of a smooth surface of the T-series carbon fiber, the vibrating noise is reduced and thus the acoustic quality of the dome is improved.

In the exemplary embodiments of the present disclosure, the carbon fiber dome may include a plurality of carbon fiber layers, e.g., two carbon fiber layers, or more than two carbon fiber layers, e.g., three carbon fiber layers, four carbon fiber layers, five carbon fiber layers or even more. However, it should be guaranteed that, the carbon fiber prepreg of the plurality of carbon fiber layers includes at least two types of carbon fiber materials, for example, includes both the T-series carbon fiber and the M-series carbon fiber, and the mode of the carbon fiber can be determined according to requirements on the dome product. In an exemplary embodiment of the present disclosure, the carbon fiber dome is formed by compounding a plurality of layers of carbon fiber prepreg, so that the formed dome can have good mechanical strength and a small thickness, i.e., having complex properties of both good strength and good vibrating resilience at the same time. In an exemplary embodiment, the thickness of the carbon fiber dome is 40˜250 μm, which guarantees both the strength and convenience for manufacturing. In addition to the improvement on mechanical strength, the acoustic quality is also improved. Further, as the dome is made of merely one kind of material, the purity of the sound is guaranteed, especially when the thickness of the carbon fiber dome is 80˜150 μm, the carbon fiber dome can have good frequency characteristics and cover a wider sounding range.

FIG. 2 shows a carbon fiber dome compounded by three carbon fiber layers, and FIG. 3 shows a carbon fiber dome compounded by four carbon fiber layers. The carbon fiber dome 200 in FIG. 2 may use three modes of carbon fibers. For example, the top layer use a T-series carbon fiber prepreg 210, e.g., T500 carbon fiber, the middle layer uses a M-series carbon fiber prepreg 220, e.g., M55 carbon fiber, and the lower layer uses a T-series carbon fiber prepreg 230, e.g., T300 carbon fiber, and the three layers are compounded into an integrated material with high strength, meanwhile the formed dome is not fragile. The carbon fiber dome 300 in FIG. 3 may use four modes of carbon fibers. The carbon fiber prepreg 310 of the topmost layer use T300 carbon fiber, the carber fiber prepregs 320, 330 of the two middle layers use M35 carbon fiber and M55 carbon fiber, respectively. The carbon fiber prepreg 340 of the lowest layer uses T400 carbon fiber. The two middle layers of M-series carbon fibers impart good toughness and reliability during long-term vibration to the dome, so that the dome will not readily crack or break. Further, carbon fibers in each layer can be structured into a unidirectional tape, and carbon fibers in one layers are perpendicular to carbon fibers in an adjacent layer, so that the dome can bear a uniform force in various directions. The integrated structure formed after high temperature and high pressure compounding has high strength, and will not readily crack or break. Additionally, The T-series carbon fiber materials in the topmost layer and the lowest layer has high strength, which imparts good strength to the whole dome; further, the T-series carbon fiber prepreg cures to form a smooth surface, so that less noise will be generated during vibration.

In the present disclosure, the dome is formed by a plurality of carbon fiber layers, the carbon fiber layer may be a unidirectional tape, a woven fabric or a multi-directionally woven carbon fiber fabric, and the carbon fibers in the plurality of carbon fiber layers are intersecting with each other at a certain angle, so that the dome is capable of bearing forces in various directions. Further, an included angle between carbon fibers of each two adjacent carbon fiber layers is set at 0˜90 degrees, e.g., 30 degrees, 45 degrees, 60 degrees, etc.

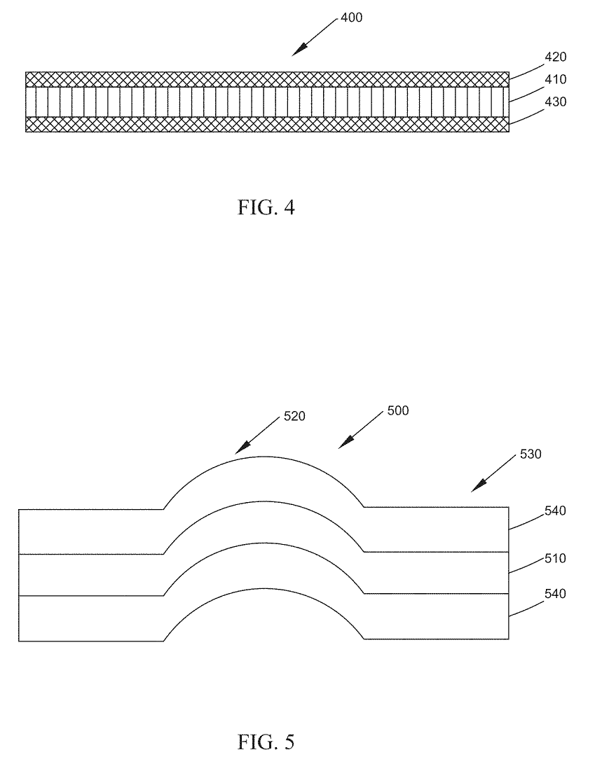

In the present disclosure, each two adjacent carbon fiber layers of the carbon fiber dome uses different modes of carbon fibers, and such arrangement is advantageous in satisfying requirements on the dome, for example, if merely M55 carbon fiber is used, it will be difficult to form a carbon fiber dome with smooth external appearance. As shown in FIG. 4, an exemplary embodiment of the present disclosure provides a carbon fiber dome 400 compounded by three carbon fiber layers, i.e., one M55 carbon fiber prepreg 410 in the middle and one T300 carbon fiber woven fabric prepreg 420, 430 at each side. A thickness of the M55 carbon fiber prepreg 410 is 80 μm, and a thickness of each of the carbon fiber woven fabric prepregs 420, 430 is 10 μm, thus, the M55 carbon fiber guarantees vibrating elasticity and resilience of the carbon fiber dome 400, and the T300 carbon fiber at the surface imparts smooth external appearance to carbon fiber dome 400. In the present embodiment, the thicknesses of the plurality of carbon fiber layers of the carbon fiber dome may be identical or different, and a ratio between each two adjacent carbon fiber layers is set at 1:20˜1:1.

In the present disclosure, the carbon fiber prepreg includes a carbon fiber material and a prepreg resin, the carbon fiber prepreg can bear a greater force in a fiber direction, i.e., the extending direction of the fiber, and bear a smaller force in a direction perpendicular to the fiber direction. However, the force bearing capability will be significantly improved after the resin cures. The prepreg resin may include at least one of epoxy resin, poly(ether-ether-ketone) (PEEK), polyimide (PI), polyphenylene sulfide (PPS), poly(p-phenylenebenzobisoxazole) (PBO) and poly-p-phenylene terephthamide (aramid fiber 1414). A tensile modulus of the carbon fiber material is more than 200 Gpa, and the carbon fiber material is a microcrystalline graphnite material obtained by a method in which organic fibers (e.g., sheet-like graphnite microcrystals) are stacked along an axis direction of the fiber and are then carbonized and graphitized. The carbon fiber is soft inside but hard outside, and is lighter in mass than the aluminum metalbut greater in strength than steel or iron. Further, the carbon further has properties like anti-corrosion and high modulus. In practice, the carbon fiber may be selected from T-series (mode: T−m, m≥300) carbon fibers and all M-series carbon fibers of Toray corporation, and other series of carbon fibers or carbon fibers from other suppliers with the same level of strength. Accordingly, the mechanical property of the dome of the present disclosure can be greatly improved, meanwhile the dome will be lighter and thinner, further, the layers of the dome are closely attached to each other and thus the dome has improved water-proof performance.

During manufacturing, it is only necessary to get a plurality of carbon fiber prepreg attached to each other. As the carbon fiber prepreg itself is adhesive, bonding can be achieved without an extra binder, then a high temperature and high pressure process is performed to make the prepreg resin in the carbon fiber prepreg cure, so that the bonding strength of the cured carbon fiber unidirectional tape prepreg will be further improved, and the carbon fiber layers can be laminated more tightly, so as to guarantee the force bearing strength of the dome. Further, the cured resin can further improve the high-frequency performance of the dome. By using the carbon fiber, the overall thickness of the dome is reduced, so that the vibrating performance and sound quality are guaranteed and the dome will occupy relatively less space. Additionally, the carbon fiber prepreg can provide smooth surface to the dome after the resin cures, further, the cured resin is hard and will not readily be scratched, so that the carbon fiber dome can be more aesthetic in appearance.

The dome in the present disclosure may be shaped as a flat plate or a semi-sphere; and the semi-sphere carbon fiber dome can have better high-frequency performance. As shown in FIG. 5, a carbon fiber dome 500 is provided according to some exemplary embodiments of the present disclosure. The carbon fiber dome 500 includes a M55 carbon fiber prepreg 510 (unidirectional tape) in the middle and a T300 carbon fiber prepregs 540 at each side of the M55 carbon fiber unidirectional tape prepreg 510. The carbon fiber dome 500 is obtained by compounding the M55 carbon fiber prepreg 510 and the T300 carbon fiber prepregs 540 under high temperature and high pressure. The carbon fiber dome 500 further includes a convex portion 520 and a flat portion 530, and the flat portion 530 surrounds the convex portion 520.

After the carbon fiber dome of the present disclosure is formed, the carbon fiber dome is further processed into a demanded shape by cutting, e.g., laser cutting, trimming die punching, die cutting by a die-cutting machine, etc., then adhered to the voice coil to form a vibration unit, e.g., by means of gum or glue, and finally assembled to form a speaker.

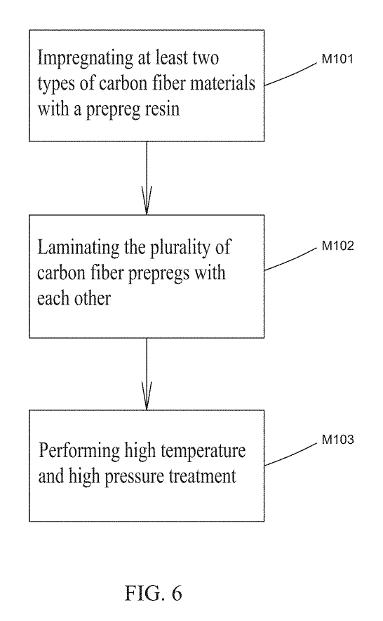

In another aspect, in order to manufacture the abovementioned carbon fiber dome with excellent mechanical and acoustic performance and aesthetic appearance, the present disclosure provides a method for manufacturing the carbon fiber dome, and the method is simple and reliable, and the dome manufactured thereby has excellent performance FIG. 6 shows a method for manufacturing a carbon fiber dome, including steps of: M101 forming a plurality of carbon fiber prepregs by impregnating at least two types of carbon fiber materials with a prepreg resin; M102 laminating the plurality of carbon fiber prepregs with each other; M103 performing high temperature and high pressure treatment to tightly laminate the carbon fiber tapes. In step M102, no extra binder is needed, as the impreganted carbon fiber material itself is adhesive. The method is simple, reliable and convenient for operation. The prepreg resin is selected from a group consisting of one of epoxy resin, poly(ether-ether-ketone) (PEEK), polyimide (PI), polyphenylene sulfide (PPS), poly (p-phenylenebenzobisoxazole) (PBO), poly-p-phenylene terephthamide (aramid fiber 1414) and combinations thereof.

In the method for manufacturing the dome of the present disclosure, the composite layer can be formed by merely adhering and reinforcing under high temperature and high pressure, and the obtained dome has excellent mechanical and acoustic performance, aesthetic appearance and good water-proof effect and will not readily splitting. The method is simple and easy to operate, and has less demands on the equipment and has a wide application prospect.

The above are merely exemplary embodiments of the present disclosure. It should be noted that, those skilled in the art can make improvements to the present disclosure without departing from the invention concept of the present disclosure, and all these improvements shall fall into the protection scope of the present disclosure.

1. A carbon fiber dome, comprising at least two carbon fiber prepreg layers, wherein the at least two carbon fiber prepreg layers comprise at least two types of carbon fiber materials, each of the at least two carbon fiber prepreg layers comprises a type of carbon fiber material and a prepreg resin, the prepreg resin comprises at least one of poly (p-phenylenebenzobisoxazole) and poly-p-phenylene terephthamide.

2. The carbon fiber dome as described in claim 1, where a thickness of the carbon fiber dome is 40˜250 μm.

3. The carbon fiber dome as described in claim 2, wherein a thickness of the carbon fiber dome is 80˜150 μm.

4. The carbon fiber dome as described in claim 1, wherein an included angle between carbon fibers of each two adjacent carbon fiber prepreg layers is within a range of 0°˜90°.

5. The carbon fiber dome as described in claim 1, wherein a thickness ratio of each two adjacent carbon fiber prepreg layers is within a range of 1:20˜1:1.

6. The carbon fiber dome as described in claim 1, wherein a tensile modulus of each type of carbon fiber material is greater than 200 Gpa.

7. (canceled)

8. The carbon fiber dome as described in claim 1, wherein the at least two types of carbon fiber materials comprise M-series carbon fibers and T-series carbon fibers.

9. The carbon fiber dome as described in claim 8, comprising a top carbon fiber prepreg layer, a middle carbon fiber prepreg layer and a lower carbon fiber prepreg layer, and the top carbon fiber prepreg layer, the middle carbon fiber prepreg layer and the lower carbon fiber prepreg layer are sequentially stacked, the middle carbon fiber prepreg layer uses M55 carbon fiber, the top carbon fiber prepreg layer and the lower carbon fiber prepreg layer respectively use T300 carbon fiber.

10. The carbon fiber dome as described in claim 9, wherein a thickness of the middle carbon fiber prepreg layer is 80 μm, a thickness of each of the top carbon fiber prepreg layer and the lower carbon fiber prepreg layer is 10 μm.

11. A method for manufacturing the carbon fiber dome according to claim 1, comprising steps of:
impregnating at least two types of carbon fiber materials with a prepreg resin to form at least two carbon fiber prepreg layers; and
laminating the at least two carbon fiber prepreg layers after being impregnated.
